(19) United States
(12) Patent Application Publication
(10) Pub. No.: US 2025/0141584 A1
(43) Pub. Date: May 1, 2025

(54) OPTICAL TRANSMISSION DEVICE, OPTICAL TRANSMISSION METHOD, AND OPTICAL TRANSMISSION SYSTEM

(71) Applicant: Fujitsu Limited, Kawasaki-shi (JP)

(72) Inventor: Tokuharu KIMURA, Isehara (JP)

(73) Assignee: Fujitsu Limited, Kawasaki-shi (JP)

(21) Appl. No.: 18/906,745

(22) Filed: Oct. 4, 2024

(30) Foreign Application Priority Data
Oct. 26, 2023 (JP) 2023-184048

(51) Int. Cl. H04J 14/02

(52) U.S. Cl. CPC H04J 14/0227

(57) ABSTRACT

An optical transmission device includes a receiver receiving, from an transmission line, a wavelength division multiplexing (WDM) signal obtained by multiplexing first to third optical signals after power of each of the first to third optical signals is adjusted, the first to third optical signals having wavelengths belonging to first to third wavelength bands, respectively, the second wavelength band being longer than the first wavelength band, the third wavelength band being shorter than the first wavelength band, an amplifier outputting a pump light propagating in a direction opposite to a propagation direction of the WDM signal and amplifying the WDM signal, and a controller controlling an amplification gain based on a quality of the third optical signal calculated by power of the third optical signal before being transmitted to the transmission line and power of the third optical signal included in the received WDM signal.

### CROSS-REFERENCE TO RELATED APPLICATION

This application is based upon and claims the benefit of priority of the prior Japanese Patent Application No. 2023-184048, filed on Oct. 26, 2023, the entire contents of which are incorporated herein by reference.

### FIELD

A certain aspect of embodiments described herein relates to an optical transmission device, an optical transmission method, and an optical transmission system.

### BACKGROUND

Wavelength division multiplexing (WDM) transmission may be performed using a plurality of wavelength bands such as a conventional band (C band) and a long band (L band) as disclosed in, for example, Japanese Patent Application Laid-Open No. 2003-188831 (Patent Document 1). The C band tends to be defined as the band from 1529.55 nm (nanometers) to 1563.86 nm. The L band tends to be defined as the band from 1567.95 nm to 1604.02 nm. Thus, the L band is a longer wavelength band than the C band.

When WDM transmission is performed, optical power on the short-wavelength side decreases and the optical power on the long-wavelength side increases by the stimulated Raman scattering (SRS) phenomenon. As a result, at the reception node, a tilt is generated in which the optical power of the optical signal on the short-wavelength side is small and the optical power of the optical signal on the long-wavelength side is large. When the tilt is generated in the optical power, a tilt in the optical signal to noise ratio (OSNR) is also generated due to the generation of the tilt, in which the OSNR on the short-wavelength side is small and the OSNR on the long-wavelength side is large. The generation of such tilt causes transmission performance degradation of a WDM transmission system. For example, when the tilt is generated in the OSNR, it is difficult to increase transmission capacity and extend transmission distance.

In order to inhibit the generation of the tilt in the OSNR, control called pre-emphasis may be performed. The pre-emphasis is, for example, control for adjusting the optical power of the short wavelength band at the transmission node in advance. The pre-emphasis reduces the tilt of the OSNR in each wavelength band at the reception node. That is, the OSNR in each wavelength band at the reception node may become flat. Thus, execution of the pre-emphasis improves the transmission performance of WDM transmission. Such optical pre-emphasis is sometimes referred to as OSNR pre-emphasis as disclosed in, for example, U.S. Patent Application Publication No. 2002/0191903 (Patent Document 2).

### SUMMARY

Meanwhile, new WDM transmission using not only the C band and the L band described above but also an S band (short band) is being studied to further improve transmission performance. The S band tends to be defined as the band from 1489.70 nm to 1522.56 nm. That is, the S band is a shorter wavelength band than the C band. In the new WDM transmission in which the band is extended to the S band, the tilt of the received power due to the SRS may increase due to the widened wavelength band, compared to the case of the WDM transmission using the C band and the L band.

Although the tilt of the received power in the S band caused by the SRS is expected to be eliminated by the existing pre-emphasis described above, there is a possibility that the transmission performance of the WDM transmission is not sufficiently improved. That is, in the new WDM transmission in which the band is extended to the S band, even if the pre-emphasis is performed, a tilt remains in a generalized SNR (GSNR), which is the quality of an optical signal in which nonlinear noise generated in the optical fiber transmission line is considered, and there is a possibility that the transmission performance is not improved. This makes band expansion into the S band difficult.

In view of the above, it is desirable to provide an optical transmission device, an optical transmission method, and an optical transmission system that reduces transmission performance degradation due to band expansion.

In one aspect of the present disclosure, there is provided an optical transmission device including: a reception unit that receives, from an optical transmission line, a WDM signal obtained by multiplexing a first optical signal, a second optical signal, and a third optical signal after optical power of each of the first optical signal, the second optical signal, and the third optical signal is adjusted, the first optical signal having a wavelength belonging to a first wavelength band, the second optical signal having a wavelength belonging to a second wavelength band longer than the first wavelength band, the third optical signal having a wavelength belonging to a third wavelength band shorter than the first wavelength band; an amplification unit that amplifies the WDM signal based on an output to the optical transmission line of a pump light propagating in a direction opposite to a propagation direction of the WDM signal; and a control unit that controls a gain of the amplification unit based on a quality of the third optical signal calculated based on optical power of the third optical signal before being transmitted to the optical transmission line and optical power of the third optical signal included in the WDM signal received by the reception unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an example of an optical network.

FIG. 2 illustrates an example of an optical transmission system.

FIG. 3 illustrates an example of functional configurations of a transmission node control unit and a reception node control unit.

FIG. 4 is a flowchart illustrating an example of the operation of the optical transmission system in the first embodiment.

FIG. 5A illustrates an example of optical power before pre-emphasis control is performed in a transmission node, FIG. 5B illustrates an example of optical power when the pre-emphasis control is not performed in a reception node, and FIG. 5C illustrates an example of the SNR when the pre-emphasis control is not performed.

FIG. 6A illustrates an example of optical power after the pre-emphasis control is performed in the transmission node, FIG. 6B illustrates an example of optical power in the reception node after the pre-emphasis control is performed, and FIG. 6C illustrates an example of the SNR after the pre-emphasis control is performed.

FIG. 7A illustrates an example of optical power in the transmission node in a comparative example, FIG. 7B illustrates an example of optical power in the reception node in the comparative example, and FIG. 7C illustrates an example of the SNR in the comparative example.

FIG. 8 illustrates an example of gain characteristics of backward Raman amplification.

FIG. 9A illustrates an example of optical power in the transmission node in the first embodiment, FIG. 9B illustrates an example of optical power in the reception node in the first embodiment, and FIG. 9C illustrates an example of the SNR in the first embodiment.

FIG. 10 is a diagram for describing an example of the advantage of the first embodiment.

FIG. 11 is a flowchart partially illustrating an example of the operation of the optical transmission system in a second embodiment.

FIG. 12A illustrates an example of optical power in the transmission node in the second embodiment, FIG. 12B illustrates an example of optical power in the reception node in the second embodiment, and FIG. 12C illustrates an example of the SNR in the second embodiment.

FIG. 13 illustrates a diagram for describing an example of the advantage in the second embodiment.

FIG. 14 is a flowchart partially illustrating an example of the operation of the optical transmission system in another embodiment.

FIG. 15 illustrates an example of a functional configuration of a backward Raman control unit in a third embodiment.

### DESCRIPTION OF EMBODIMENTS

Hereinafter, embodiments for carrying out the present disclosure will be described with reference to the drawings.

### First Embodiment

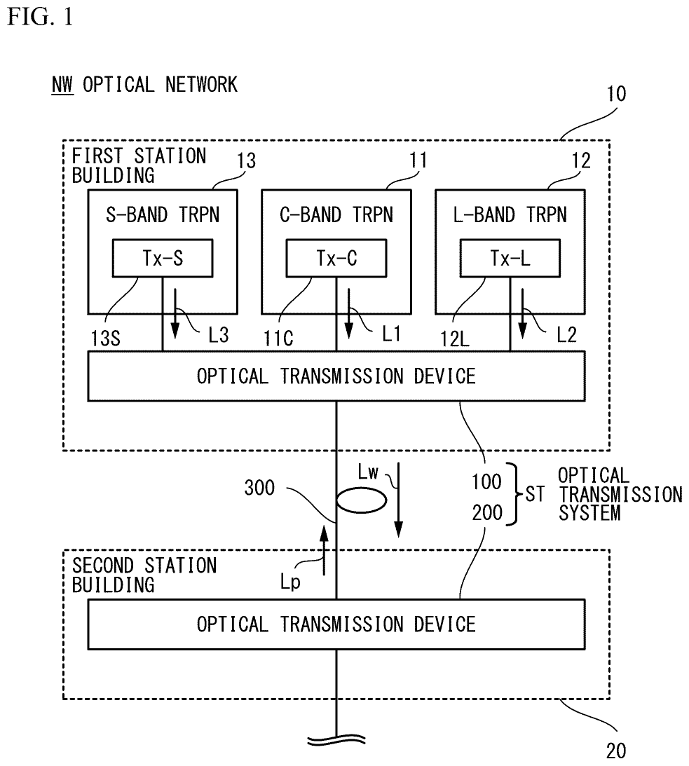

As illustrated in FIG. 1, an optical network NW includes a C-band transponder (denoted by TRPN in FIG. 1) 11, an L-band transponder 12, and an S-band transponder 13. The optical network NW includes an optical transmission device 100 as a transmission node and an optical transmission device 200 as a reception node. The optical transmission device 100 is an example of a first optical transmission device. The optical transmission device 200 is an example of a second optical transmission device.

The optical transmission devices 100 and 200 may be, for example, reconfigurable optical add/drop multiplexers (ROADMs) or in-line amplifier equipment (ILA). The C-band transponder 11, the L-band transponder 12, the S-band transponder 13, and the optical transmission device 100 are installed in, for example, a first station building 10 of a communication company. The first station building 10 includes, for example, a terminal station building. The optical transmission device 200 is installed in a second station building 20 that is several tens of kilometers away from the first station building 10, for example. The second station building 20 includes, for example, a relay station building.

The optical transmission devices 100 and 200 are connected to each other by an optical transmission line 300. The optical transmission line 300 may be an optical fiber such as a single mode fiber (SMF) or an optical fiber other than the SMF such as a dispersion shifted fiber (DSF). The optical transmission devices 100 and 200 can implement an optical transmission system ST.

The C-band transponder 11 includes a transmitter (denoted by Tx-C in FIG. 1) 11C that transmits a C-band optical signal L1. The C band is an example of a first wavelength band. The optical signal L1 includes a plurality of wavelengths (for example, 48 wavelengths) belonging to the C band. In the present embodiment, the wavelength band from 1531.12 nm to 1563.97 nm is used as the C band.

The L-band transponder 12 includes a transmitter (denoted by Tx-L in FIG. 1) 12L that transmits a L-band optical signal L2. The L band is an example of a second wavelength band. The optical signal L2 includes a plurality of wavelengths (for example, 48 wavelengths) belonging to the L band. In the present embodiment, the wavelength band from 1566.31 nm to 1600.71 nm is used as the L band. Thus, the L band is a wavelength band longer than the C band.

The S-band transponder 13 includes a transmitter (denoted by Tx-S in FIG. 1) 13S that transmits an S-band optical signal L3. The S band is an example of a third wavelength band. The optical signal L3 includes a plurality of wavelengths (for example, 48 wavelengths) belonging to the S band. In the present embodiment, the wavelength band from 1497.47 nm to 1528.87 nm is used as the S band. Thus, the S band is a shorter wavelength band than the C band.

The optical transmission device 100 receives the optical signals L1, L2, and L3 transmitted from the transmitters 11C, 12L, and 13S, respectively. When receiving the optical signals L1, L2, and L3, the optical transmission device 100 controls and adjusts the optical power of each of the optical signals L1, L2, and L3. The optical transmission device 100 performs pre-emphasis control on the optical signals L1, L2, and L3, which will be described in detail later. After controlling and adjusting the optical power of each of the optical signals L1, L2, and L3, the optical transmission device 100 multiplexes the optical signals L1, L2, and L3 and outputs a wavelength division multiplexing (WDM) signal obtained by multiplexing the optical signals L1, L2, and L3 to the optical transmission line 300 as a WDM signal Lw. Thus, the WDM signal Lw propagates through the optical transmission line 300 toward the optical transmission device 200.

The optical transmission device 200 receives the WDM signal Lw from the optical transmission line 300 as a reception node. When receiving the WDM signal Lw, the optical transmission device 200 amplifies the WDM signal Lw and outputs it to the downstream of the optical transmission device 200. Although details will be described later, the optical transmission device 200 outputs a pump light Lp propagating in the direction opposite to the propagation direction of the WDM signal Lw to the optical transmission line 300. The pump light Lp amplifies the WDM signal Lw by the Raman amplification phenomenon. In this manner, the WDM signal Lw is optically amplified in the optical transmission line 300.

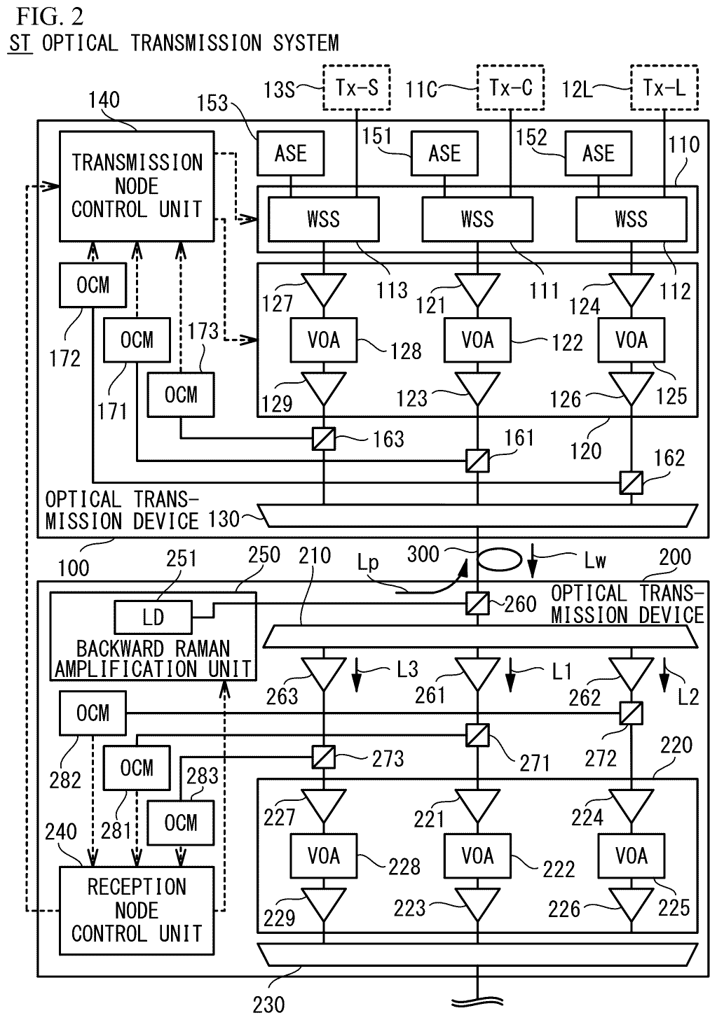

The optical transmission devices 100 and 200 included in the optical transmission system ST will be described in detail with reference to FIG. 2.

First, the optical transmission device 100 will be described. The optical transmission device 100 includes an optical power first adjustment unit 110, an optical power second adjustment unit 120, a transmission node multiplexer 130, and a transmission node control unit 140. The optical transmission device 100 includes a plurality of amplified spontaneous emission (ASE) light sources 151, 152, 153, a plurality of optical fiber couplers 161, 162, 163, and a plurality of optical channel monitors (OCMs) 171, 172, 173. Although details will be described later, the ASE light sources 151, 152, and 153 may not be necessarily included in the optical transmission device 100.

The optical power first adjustment unit 110 includes a wavelength selective switch (WSS) 111 for the C band, a WSS 112 for the L band, and a WSS 113 for the S band. Although omitted in FIG. 2, the WSS 111 is optically connected to the ASE source 151 and a fiber from the other path. The WSS 112 is optically connected to the ASE light source 152 and a fiber from the other path. The WSS 113 is optically connected to the ASE light source 153 and a fiber from the other path.

The WSS 111 divides the ASE light beam emitted from the ASE light source 151 into ASE light beams of respective wavelengths to generate dummy optical signals for the respective wavelengths. The dummy optical signal is a pseudo optical signal. The WSS 111 can be controlled to allow dummy wavelengths of the ASE light source to pass therethrough for the wavelengths of the optical signal, so that the maximum number of wavelengths is always achieved. This makes it possible to avoid the influence of the level fluctuation of each channel with respect to the number of wavelengths, such as SRS tilt, caused by the change in the number of wavelengths.

The WSS 111 adjusts the transmission power of each wavelength channel of the optical signal L1 based on the first optical power control by the transmission node control unit 140. For example, when detecting the first optical power control, the optical power first adjustment unit 110 controls the WSS 111 to increase the transmission power on the short-wavelength side of the optical signal L1 to be higher than the transmission power on the long-wavelength side. If the transmission power of each wavelength channel of the optical signal L1 is flat, an intentional tilt is generated in the transmission power of each wavelength channel of the optical signal L1 by the first optical power control. In this manner, when the transmission power of each wavelength channel of the optical signal L1 is adjusted, the tilt of the received power of the optical signal L1 is improved in the optical transmission device 200, compared to a case where the transmission power is not adjusted.

The WSSs 112 and 113 are basically the same as the WSS 111, and therefore, detailed description thereof will be omitted.

The optical power second adjustment unit 120 includes optical amplifiers 121 and 123 for the C band and a variable optical attenuator (VOA) 122 for the C band. The optical amplifiers 121 and 123 include, for example, erbium doped fiber amplifiers (EDFA). The optical amplifier 121 amplifies the optical signal L1 output from the WSS 111. The VOA 122 attenuates the optical signal L1 output from the optical amplifier 121. The optical amplifier 123 amplifies the optical signal L1 output from the VOA 122.

The optical power second adjustment unit 120 adjusts the optical power of each of the optical signals L1, L2, and L3 based on the second optical power control by the transmission node control unit 140. For example, when detecting the second optical power control, the optical power second adjustment unit 120 controls the optical amplifiers 121 and 123 and the VOA 122 to increase the transmission power of each wavelength channel of the optical signal L1 on the short-wavelength side to be higher than the transmission power on the long-wavelength side. If the transmission power of each wavelength channel of the optical signal L1 is flat, an intentional tilt is generated in the transmission power of each wavelength channel of the optical signal L1 by the second optical power control. In this manner, when the transmission power of each wavelength channel of the optical signal L1 is adjusted, the tilt of the received power of the optical signal L1 is improved in the optical transmission device 200, compared to a case where the transmission power is not adjusted.

The optical power second adjustment unit 120 includes optical amplifiers 124 and 126 for the L band and a VOA 125 for the L band. The optical power second adjustment unit 120 includes optical amplifiers 127 and 129 for the S band and a VOA 128 for the S band. Therefore, when the optical power second adjustment unit 120 adjusts the transmission power of each of the optical signals L2 and L3 in the same manner as the case of the optical signal L1, the tilt of the received power of each of the optical signals L2 and L3 is improved in the optical transmission device 200. In the present embodiment, the optical power second adjustment unit 120 performs tilt control of the optical signal before being transmitted to the optical transmission line 300 and average level control of transmission power, but the optical power second adjustment unit 120 may perform only tilt control, and a VOA for each band may be installed at the output end of the optical power second adjustment unit 120 to perform average level control of transmission power of each wavelength band.

As described above, even when the pre-emphasis control is performed alone on the optical signals L1, L2, and L3, the tilt of the received power of the optical signals L1, L2, and L3 that appear from the shortest-wavelength side of the S band to the longest-wavelength side of the L band is improved as a whole. When the tilt of the received power is improved, the tilt of the GSNR is also improved due to the improvement in the tilt, and the transmission performance degradation is reduced. However, as will be described in detail later, even if the pre-emphasis control is performed alone, the reduction of the transmission performance degradation is insufficient. Therefore, in the present embodiment, further reduction of the transmission performance degradation will be described.

The transmission node multiplexer 130 multiplexes the optical signal L1 output from the optical amplifier 123, the optical signal L2 output from the optical amplifier 126, and the optical signal L3 output from the optical amplifier 129 to generate the WDM signal Lw. The transmission node multiplexer 130 generates the WDM signal Lw and outputs the WDM signal Lw to the optical transmission line 300.

The transmission node control unit 140 is electrically connected to the OCMs 171, 172, and 173. The OCM 171 measures the optical power of the optical signal L1 split by the optical fiber coupler 161. The optical fiber coupler 161 is provided between the optical power second adjustment unit 120 and the transmission node multiplexer 130. Therefore, the OCM 171 measures the optical power of the optical signal L1 before being multiplexed by the transmission node multiplexer 130. The OCM 171 reports the optical power of the optical signal L1 to the transmission node control unit 140. The OCMs 172 and 173 and the optical fiber couplers 162 and 163 are basically the same as the OCM 171 and the optical fiber coupler 161, and therefore, detailed description thereof is omitted.

The transmission node control unit 140 calculates a nonlinear SNR, which will be described later, based on the transmission power of each of the optical signals L1, L2, and L3 measured by the OCMs 171, 172, and 173, respectively. The nonlinear SNR is calculated for a section to optical fiber couplers 271, 272, and 273 after the WDM signal multiplexed by the transmission node multiplexer 130 is output to the optical transmission line 300 as the WDM signal Lw, demultiplexed by a reception node demultiplexer 210, and amplified by optical amplifiers 261, 262, and 263. The transmission node control unit 140 calculates the GSNRs as the signal qualities of the optical signals L1, L2, and L3 based on the nonlinear SNRs and the linear SNRs output from the optical transmission device 200. When the GSNRs are calculated, the transmission node control unit 140 performs the first optical power control and the second optical power control based on the GSNRs. The first optical power control and the second optical power control provide tilt control of the optical signal before being transmitted to the optical transmission line 300 and average level control of the transmission power of each wavelength band. In addition, the transmission node control unit 140 calculates the tilt amount of the GSNR of the S band and reports the tilt amount to the reception node control unit 240.

The linear SNR is reported from the optical transmission device 200 using, for example, an optical supervisory channel (OSC) light. The linear SNR may be reported to the transmission node control unit 140 via a network controller that manages the optical network NW.

Next, the optical transmission device 200 will be described. The optical transmission device 200 includes the demultiplexer 210, an optical power adjustment unit 220, a reception node multiplexer 230, a reception node control unit 240, and a backward Raman amplification unit 250. The optical transmission device 200 includes a WDM coupler 260, a plurality of the optical amplifiers 261, 262, 263, a plurality of the optical fiber couplers 271, 272, 273, and a plurality of OCMs 281, 282, 283. The demultiplexer 210 is an example of a reception unit and a demultiplexing unit. The reception node control unit 240 is an example of a control unit. The backward Raman amplification unit 250 is an example of an amplification unit.

The demultiplexer 210 receives the WDM signal Lw from the optical transmission line 300. When the demultiplexer 210 receives the WDM signal Lw, the demultiplexer 210 demultiplexes the WDM signal Lw into the optical signals L1, L2, and L3. The optical signal L1 is guided to the optical amplifier 261. The optical signal L2 is guided to the optical amplifier 262. The optical signal L3 is guided to the optical amplifier 263. The optical amplifier 261 amplifies the optical signal L1. The optical amplifier 262 amplifies the optical signal L2. The optical amplifier 263 amplifies the optical signal L3.

The optical power adjustment unit 220 includes optical amplifiers 221 and 223 for the C band and a VOA 222 for the C band. The optical amplifiers 221 and 223 include, for example, an EDFA. The optical amplifier 221 amplifies the optical signal L1 output from the optical amplifier 261. The VOA 222 attenuates the optical signal L1 output from the optical amplifier 221. The optical amplifier 223 amplifies the optical signal L1 output from the VOA 222.

The optical power adjustment unit 220 adjusts the optical power of each of the optical signals L1, L2, and L3 based on control (not illustrated) output from the reception node control unit 240. For example, when detecting the control, the optical power adjustment unit 220 controls the optical amplifiers 221 and 223 and the VOA 222 to adjust the optical power of the optical signal L1.

The optical power adjustment unit 220 includes optical amplifiers 224 and 226 for the L band and a VOA 225 for the L band. The optical power adjustment unit 220 includes optical amplifiers 227 and 229 for the S band and a VOA 228 for the S band. Therefore, the optical power adjustment unit 220 can adjust the optical power of each of the optical signals L2 and L3, as in the case of the optical signal L1.

The reception node multiplexer 230 multiplexes the optical signal L1 output from the optical amplifier 223, the optical signal L2 output from the optical amplifier 226, and the optical signal L3 output from the optical amplifier 229 to generate a WDM signal, and outputs the WDM signal to the downstream of the optical transmission device 200.

The reception node control unit 240 is electrically connected to the OCMs 281, 282, and 283. The OCM 281 measures the optical power of the optical signal L1 split by the optical fiber coupler 271. The optical fiber coupler 271 is provided between the optical amplifier 261 and the optical power adjustment unit 220. Therefore, the OCM 281 measures the optical power of the optical signal L1 after being amplified by the optical amplifier 261. The OCM 281 reports the optical power of the optical signal L1 to the reception node control unit 240. The OCMs 282 and 283 and the optical fiber couplers 272 and 273 are basically the same as the OCM 281 and the optical fiber coupler 271, respectively, and therefore, detailed description thereof is omitted.

The reception node control unit 240 calculates a linear SNR, which will be described later, based on the received power of each of the optical signals L1, L2, and L3 measured by the OCMs 281, 282, and 283, respectively. The linear SNR is calculated for a section to the optical fiber couplers 271, 272, and 273 after the WDM signal multiplexed by the transmission node multiplexer 130 is output to the optical transmission line 300 as the WDM signal Lw, demultiplexed by the reception node demultiplexer 210, and amplified by the optical amplifiers 261, 262, and 263. The reception node control unit 240 controls the gain of the backward Raman amplification unit 250 based on the tilt amount of the GSNR of the S band reported from the optical transmission device 100. Specifically, the reception node control unit 240 adjusts the power of each pump wavelength of the pump light Lp output from the LD (Laser Diode) 251 of the backward Raman amplification unit 250, and achieves pre-designed gain characteristics related to the backward Raman amplification.

The pump light Lp is input to the optical transmission line 300 via the WDM coupler 260. Thus, the pump light Lp propagates through the optical transmission line 300 in the direction opposite to the propagation direction of the WDM signal Lw. As a result, the WDM signal Lw is Raman-amplified by the pump light Lp in the optical transmission line 300. That is, the backward Raman amplification unit 250 amplifies the WDM signal Lw. The tilt amount of the GSNR of the S band is reported from the optical transmission device 100 by, for example, the OSC light. The tilt amount may be reported to the reception node control unit 240 via the network controller described above.

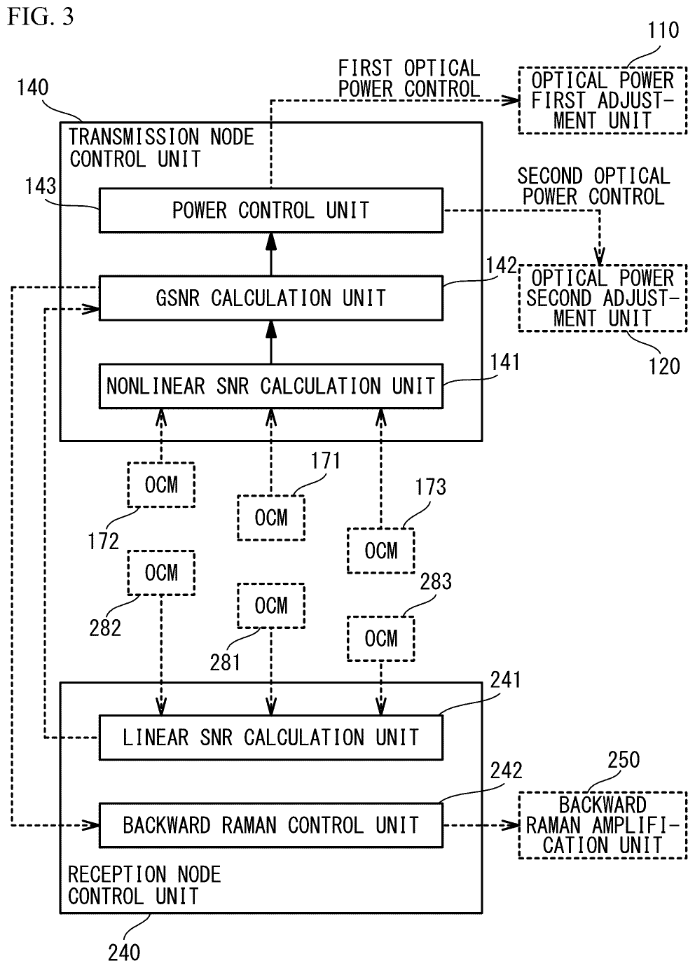

The details of the transmission node control unit 140 and the reception node control unit 240 will be described with reference to FIG. 3. The transmission node control unit 140 includes a nonlinear SNR calculation unit 141, a GSNR calculation unit 142, and a power control unit 143. The reception node control unit 240 includes a linear SNR calculation unit 241 and a backward Raman control unit 242.

The transmission node control unit 140 can be implemented by a hardware circuit such as a field programmable gate array (FPGA) and a memory. The transmission node control unit 140 may be implemented by a hardware circuit such as an application specified integrated circuit (ASIC), a digital signal processor (DSP), or a central processing unit (CPU) instead of the FPGA. The hardware configuration of the reception node control unit 240 is basically the same as that of the transmission node control unit 140, and thus a detailed description thereof will be omitted.

The nonlinear SNR calculation unit 141 of the transmission node control unit 140 calculates a nonlinear SNR as SNR_NL for each channel based on the optical power of each of the optical signals L1, L2, and L3 measured by the OCMs 171, 172, and 173 and the following equation (1).

$$SNR\_NL = \frac{P\_CH ( T ) / B\_CH}{G\_NLI} = \frac{1}{η {d ( P\_CH ( T ) / B\_CH )}^{2}} \qquad ( 1 )$$

Here, the numerator P_CH(T) represents the optical power of the measurement target wavelength channel in the optical transmission device 100 as the transmission node. That is, P_CH(T) represents the optical power of the optical signal L1 in the C band measured by, for example, the OCM 171. P_CH(T) may represent the optical power of the optical signal L2 in the L band measured by the OCM 172, or may represent the optical power of the optical signal L3 in the S band measured by the OCM 173. The numerator B_CH represents the bandwidth of the wavelength channel. Therefore, P_CH(T)/B_CH corresponds to the optical power per unit bandwidth of the measurement target wavelength channel.

The denominator G_NLI represents the optical power of nonlinear noise per unit bandwidth. G_NLI is expressed by the following equation (3) when P_NLI representing the optical power of the nonlinear noise is expressed by the following equation (2).

$$P\_NLI = {η ( P\_CH ( T ) )}^{3} \qquad ( 2 )$$

$$G\_NLI = η {d ( P\_CH ( T ) / B\_CH )}^{3} \qquad ( 3 )$$

Here, η in the equation (2) represents a known proportionality factor for calculating the nonlinear SNR. Therefore, P_NLI is proportional to, for example, the cube of the optical power of the optical signal L1 input to the transmission node multiplexer 130. In the equation (3), nd represents a known proportionality coefficient determined by the fiber type of the optical transmission line 300 or the like. Since B_CH is known, when the optical power of each of the optical signals L1, L2, and L3 is reported to the nonlinear SNR calculation unit 141, the nonlinear SNR calculation unit 141 can calculate the nonlinear SNR.

On the other hand, the linear SNR calculation unit 241 of the reception node control unit 240 calculates the linear SNR as SNR_L for each channel based on the optical power of each of the optical signals L1, L2, and L3 measured by the OCMs 281, 282, and 283 and the following equation (4).

$$SNR\_L = P\_CH / P\_ASE \qquad ( 4 )$$

Here, P_CH represents the optical power of the measurement target wavelength channel in the optical transmission device 200 as the reception node. That is, P_CH represents the optical power of the optical signal L1 in the C band measured by, for example, the OCM 281. P_CH may represent the optical power of the optical signal L2 in the L band measured by the OCM 282, or may represent the optical power of the optical signal L3 in the S band measured by the OCM 283. P_ASE represents the optical power of the ASE noise. Thus, the linear SNR is represented by the ratio of the optical power of the optical signal to the optical power of the ASE noise.

The GSNR calculation unit 142 of the transmission node control unit 140 calculates the GSNR based on the nonlinear SNR calculated by the nonlinear SNR calculation unit 141, the linear SNR calculated by the linear SNR calculation unit 241, and the following equation (5).

$$\frac{1}{GSNR} = \frac{1}{SNR\_L} + \frac{1}{SNR\_NL} \qquad ( 5 )$$

When the GSNR is calculated, the GSNR calculation unit 142 reports the GSNR to the power control unit 143. Further, when the GSNR calculation unit 142 calculates the GSNR, the GSNR calculation unit 142 calculates the tilt amount of the GSNR of the S band and reports the tilt amount to the backward Raman control unit 242 of the optical transmission device 200.

The GSNR calculated using the equations (1) to (5) can be obtained with reference to the following Documents 1 and 2, for example. In particular, P_NLI is calculated using a Gaussian noise (GN) model described in Document 1. In the first embodiment and a second embodiment described below, the nonlinear SNR is calculated using the closed-form EGN (Enhanced Gaussian noise) model described in Document 2, and the GSNR is calculated using the calculation result.
Document 1: P. Poggiolini, Analytical Modeling of Non-Linear Propagation in Coherent Systems, in Proc. OFC 2013, Anaheim, CA, USA, March 2013.
Document 2: M. Zefreh et al. “A Closed-Form Nonlinearity Model for Forward-Raman-Amplified WDM Optical Links,” in Proc. Opt. Fiber Commun. Conf. (OFC), Paper M5C.1, 2021.

The power control unit 143 of the transmission node control unit 140 performs the first optical power control on the optical power first adjustment unit 110 and the second optical power control on the optical power second adjustment unit 120 based on the GSNR reported from the GSNR calculation unit 142. For example, when the GSNR is not flat, the power control unit 143 performs pre-emphasis control to reduce the tilt of the received power generated in the optical transmission device 200 and improve the flatness of the GSNR. The power control unit 143 can improve the GSNR by performing pre-emphasis control based on the frequency characteristics of the launch power for each channel described in Document 3 below.
Document 3: Pierluigi Poggiolini et al. “Closed Form Expressions of the Nonlinear Interference for UWB Systems,” ECOC 2022, paper Tu1D.1.

The backward Raman control unit 242 of the reception node control unit 240 controls the gain of the backward Raman amplification unit 250 based on the tilt amount of the GSNR of the S band reported from the GSNR calculation unit 142. For example, when the minimum GSNR on the short-wavelength side of the S band is smaller than the GSNR on the long-wavelength side of the S band, that is, when a GSNR tilt is generated, the backward Raman control unit 242 performs tilt control for compensating for this GSNR tilt. In this case, the backward Raman control unit 242 adjusts the wavelength and the optical power of the pump light Lp output from the backward Raman amplification unit 250 so that the improvement in the minimum GSNR on the short-wavelength side of the S band is larger than the improvement in the GSNR on the long-wavelength side of the S band. This improves the GSNR tilt in the S band.

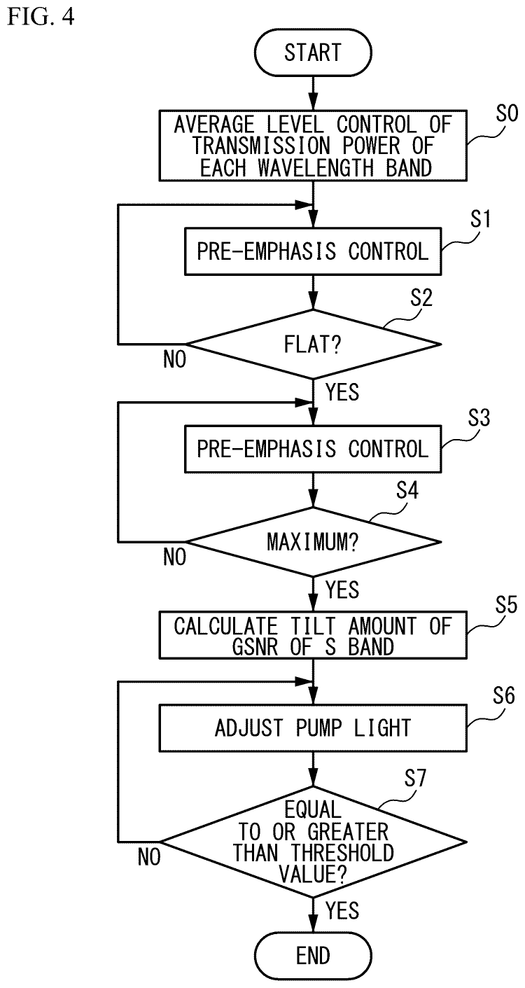

The operation of the optical transmission system ST will be described with reference to FIG. 4 to FIG. 9C. More specifically, the operation of the transmission node control unit 140 and the reception node control unit 240 in cooperation with each other will be described.

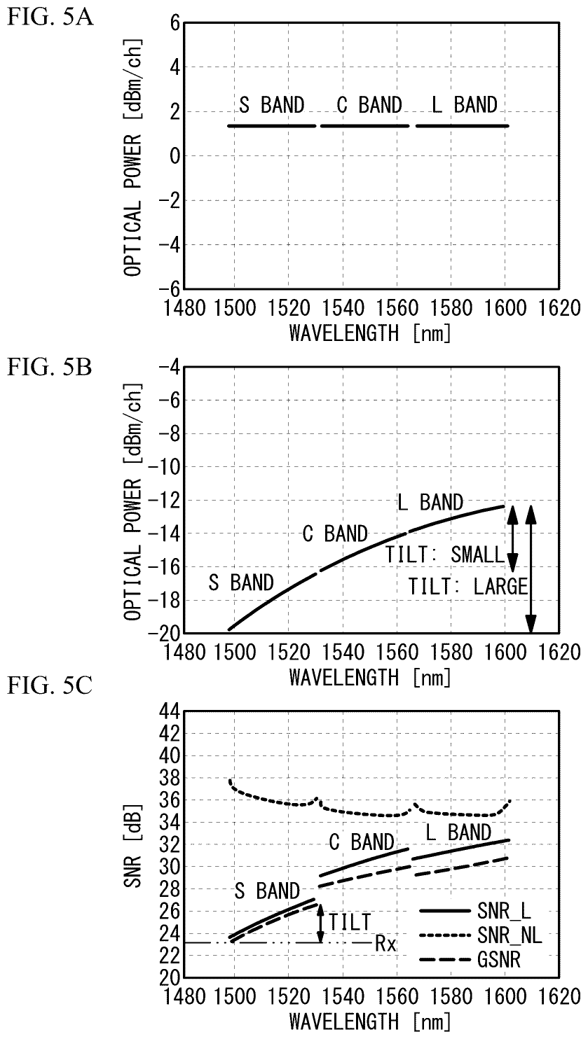

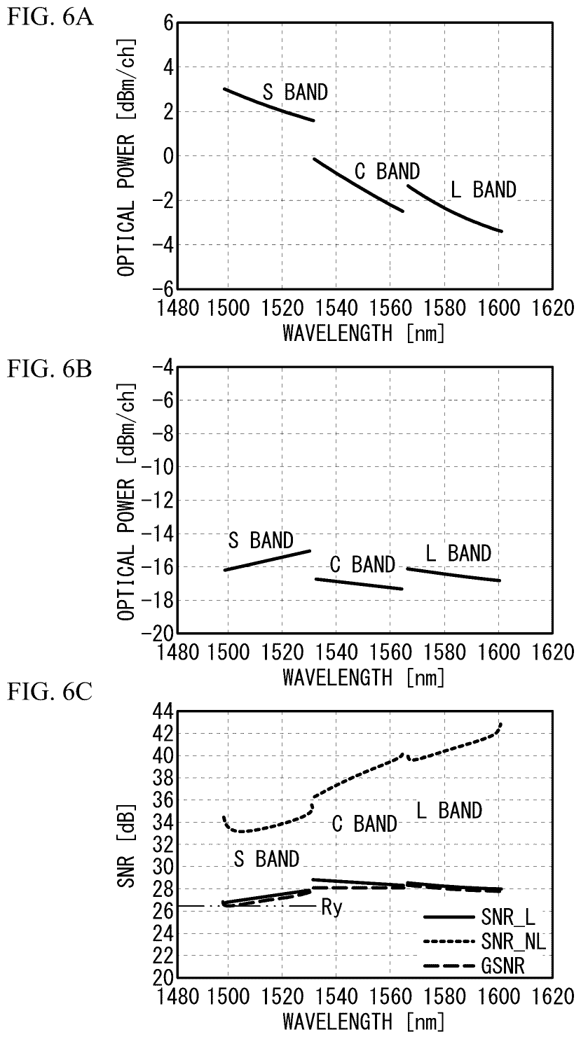

First, as illustrated in FIG. 4, the power control unit 143 performs average level control of the transmission power of each wavelength band (step S0), and then repeats pre-emphasis control until the GSNRs of both the C band and the L band become flat (step S1, step S2: NO). The power control unit 143 can determine whether the GSNR is flat based on, for example, the threshold deviation of the GSNR. For example, as illustrated in FIG. 5A, the optical signals L1, L2, and L3, whose transmission power is a constant value because the optical power of each of the S band, the C band, and the L band is all 1.32 dBm/ch, are input to the optical power second adjustment unit 120. In this case, after the average level control of the transmission power of each wavelength band, the pre-emphasis control is repeated, and thus, as illustrated in FIG. 6A, a tilt in which the transmission power of the S band increases on the short-wavelength side more than on the long-wavelength side is generated. Similarly, the tilt is generated in each of the C band and the L band. For example, the transmission power of the shortest wavelength in the S band is controlled to 3.2 dBm/ch. The optical power second adjustment unit 120 inputs the optical signals L1, L2, and L3 in this tilt-generated state to the transmission node multiplexer 130.

In addition, when the OCMs 281, 282, and 283 included in the optical transmission device 200 as the reception node measure the optical power of the optical signals L1, L2, and L3 in the state in which such a tilt is generated, the tilt of the received power is reduced as illustrated in FIG. 6B. When the linear SNR calculation unit 241 calculates the linear SNR based on the optical power measured by the OCMs 281, 282, and 283, the linear SNR having high flatness is obtained for the C band and the L band as illustrated in FIG. 6C.

On the other hand, when the nonlinear SNR calculation unit 141 calculates the nonlinear SNR based on the optical power measured by the OCMs 171, 172, and 173, as illustrated in FIG. 6C, for example, the nonlinear SNR on the short-wavelength side of the S band degrades compared to the nonlinear SNRs of the C band and the L band, and a nonlinear SNR having a large tilt appears over the S band, the C band, and the L band. This is because, as expressed by the equations (1), (2), and (3), the pre-emphasis control increases the transmission power on the short-wavelength side of the S band and increases the nonlinear noise in the S band. For example, compared to FIG. 5C under the condition of constant transmission power, the tilt of the nonlinear SNR is large in FIG. 6C due to the pre-emphasis control. When the GSNR calculation unit 142 calculates the GSNR based on the linear SNR and the nonlinear SNR according to the equation (5), the minimum GSNR (denoted by Ry in FIG. 6C) on the short-wavelength side of the S band illustrated in FIG. 6C is improved by about 3.1 dB as compared with the minimum GSNR (denoted by Rx in FIG. 5C) on the short-wavelength side of the S band illustrated in FIG. 5C. That is, the minimum GSNR on the short-wavelength side of the S band is improved by the pre-emphasis control.

When the pre-emphasis control is not performed, as illustrated in FIG. 5B, in the WDM transmission using the C band, the L band, and the S band, a very large tilt is generated in the optical power of the received signals in the S band, the C band, and the L band due to the SRS. In this case, as illustrated in FIG. 5C, a nonlinear SNR with good flatness appears, while a linear SNR with bad flatness and degradation also appears. Therefore, the minimum GSNR (denoted by Rx (<Ry) in FIG. 5C) on the short-wavelength side of the S band is significantly degraded.

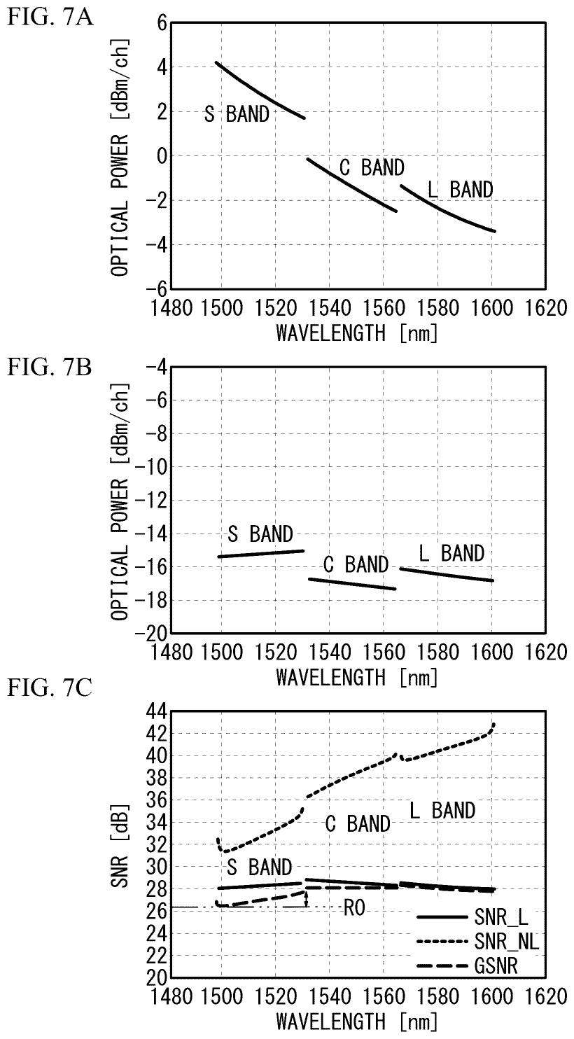

Returning to FIG. 4, when the pre-emphasis control is repeated and the GSNRs of both the C band and the L band become flat (step S2: YES), the power control unit 143 repeats the pre-emphasis control until the minimum GSNR of the S band become the maximum (step S3, step S4: NO). For example, when the pre-emphasis control is repeated, the transmission power of the shortest wavelength in the S band is controlled to 4.2 dBm/ch as illustrated in FIG. 7A.

Thus, as illustrated in FIG. 7C, the tilt of the linear SNR of the S band is reduced as compared with the case illustrated in FIG. 6C. As a result, as illustrated in FIG. 7C, the minimum GSNR of the S band is improved while the flatness of the GSNR of the C band and the GSNR of the L band is maintained. For example, the minimum GSNR “Ry” of 26.3 dB (see FIG. 6C) is improved to the minimum GSNR “R0” of 26.5 dB (see FIG. 7C).

However, as illustrated in FIG. 7C, a tilt of about 1.8 dB still remains in the GSNR of the S band due to the degradation of the nonlinear SNR. Therefore, as illustrated in FIG. 4, when the minimum GSNR of the S band becomes the maximum (step S4: YES), the GSNR calculation unit 142 calculates the GSNR tilt amount of the S band (step S5). Specifically, the GSNR calculation unit 142 calculates a difference between the maximum GSNR and the minimum GSNR of the S band, and calculates the calculated difference as a tilt amount indicating the magnitude of the tilt of the S band.

When the GSNR calculation unit 142 calculates the tilt amount, the GSNR calculation unit 142 reports the calculated tilt amount to the backward Raman control unit 242. The backward Raman control unit 242 adjusts the wavelength and the optical power of the pump light Lp based on the tilt amount of the GSNR of the S band reported from the GSNR calculation unit 142 (step S6), and determines whether the minimum GSNR of the S band is equal to or larger than the threshold value (step S7). As the threshold value, the GSNR “Rc” (for example, 28.6 dB, 29.2 dB, or the like) in WDM transmission using the C band alone may be adopted.

When the minimum GSNR is not equal to or greater than the threshold value (step S7: NO), the GSNR calculation unit 142 and the backward Raman control unit 242 repeat the processes of steps S6 and S7. When the minimum GSNR of the S band is equal to or greater than the threshold value (step S7: YES), the transmission node control unit 140 and the reception node control unit 240 each end the process.

Here, the details of the above-described step S6 will be described. The backward Raman control unit 242 adjusts the wavelength and the optical power of the pump light Lp, and controls the gain of the backward Raman amplification unit 250 so as to compensate for the tilt relating to the GSNR of the S band reported from the GSNR calculation unit 142. For example, the backward Raman control unit 242 adjusts the pump light Lp with a wavelength of 1395 nm to be input to the optical transmission line 300 with optical power of 0.08 W (watt).

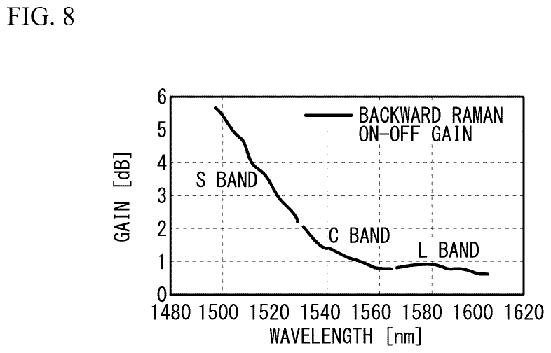

As illustrated in FIG. 8, such adjustment allows the backward Raman amplification unit 250 to achieve gain characteristics in which the gain is higher on the shorter wavelength side of the S-band. Since the gain on the shorter wavelength side of the S band is to be higher, the gain on the short-wavelength side of the S band is to be higher than at least the gain on the long-wavelength side of the S band. Therefore, the gain on the short-wavelength side of the S band may be higher than the gain on the short-wavelength side or the long-wavelength side of the C band, or may be higher than the gain on the short-wavelength side or the long-wavelength side of the L band. As described above, the backward Raman control unit 242 controls the gain of the backward Raman amplification unit 250.

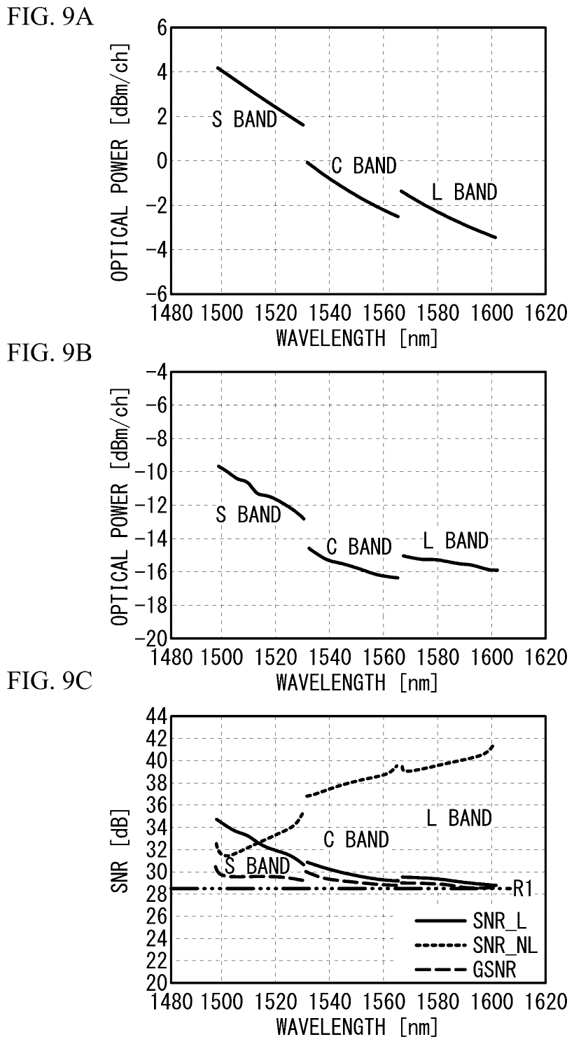

Accordingly, as illustrated in FIG. 9A, when Raman amplification by the pump light Lp is performed in a state where a tilt is generated in the transmission power as in the case illustrated in FIG. 7A, the received power of each of the S band, the C band, and the L band increases as a whole as illustrated in FIG. 9B. For example, the received power of the shortest wavelength in the S band increases by about 5 dBm as compared with the received power of the shortest wavelength in the S band described with reference to FIG. 7B. As a result, as illustrated in FIG. 9C, the minimum GSNR of the S band is improved while the flatness of the GSNR of the C band and the GSNR of the L band is maintained. For example, in the entire S band, C band, and L band, the minimum GSNR “R0” of 26.5 dB (see FIG. 7C) is improved to the minimum GSNR “R1” of 28.6 dB (see FIG. 9C).

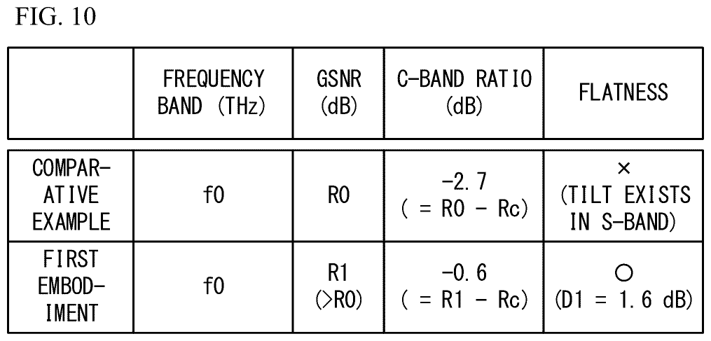

Referring to FIG. 10, the advantage of the first embodiment will be described in comparison with a comparative example. The frequency band “f0” (for example, 12.6 THz (terahertz)) in the first embodiment is common to the comparative example. The frequency band “f0” corresponds to the wavelength band from the shortest wavelength of the S band to the longest wavelength of the L band in the first embodiment.

In such a frequency band “f0”, the minimum GSNR “R0” is calculated in the comparative example. On the other hand, in the first embodiment, the minimum GSNR “R1” larger than the minimum GSNR “R0” is calculated. As described above, in the first embodiment, the GSNR is improved as compared with the comparative example. Further, when the C-band ratio of the comparative example is compared with the C-band ratio of the first embodiment, the GSNR “R1” of the first embodiment is closer to the GSNR “Rc” in the WDM transmission using the C band alone than the comparative example. That is, in the first embodiment, it is possible to obtain transmission performance close to WDM transmission of the C band alone, compared to the comparative example. Note that the relative C-band ratio of the comparative example represents the difference between the minimum GSNR “R0” and the GSNR “Rc”, and the relative C-band ratio of the first embodiment represents the difference between the minimum GSNR “R1” and the GSNR “Rc”.

Regarding the flatness of the GSNR, in the comparative example, the GSNR tilt remains in the S band, and therefore, the improvement in the flatness is insufficient. However, in the first embodiment, the tilt in the S band is improved, and the deviation D1 is reduced to about 1.6 dB in all the GSNRs of the S band, the C band, and the L band. When the deviation is set to 2.0 dB, for example, the flatness is secured to some extent. As described above, the GSNR is improved in the first embodiment as compared with the comparative example. The reason for this is as follows.

That is, since nonlinearity and noise are low in backward pumped distributed Raman amplification, it is assumed that there is no influence or an extremely small influence on SNR_NL defined as a nonlinear SNR in the above-described equation (1). In other words, even when backward pumped distributed Raman amplification is used, the degradation of the nonlinear SNR is suppressed. On the other hand, the gain of the backward pumped distributed Raman amplification improves SNR_L, which is defined as the linear SNR in the above equation (4). Therefore, when the GSNR is calculated based on the above-described equation (5), the GSNR can be improved as compared with the case where backward pumped distributed Raman amplification is not used.

As described above, according to the first embodiment, the minimum GSNR of the S band is improved and the tilt of the GSNR is reduced in a state where the flatness of the GSNRs of the C band and the L band is secured. As a result, even in WDM transmission in which the band is extended to the S band, the transmission performance degradation can be suppressed. Further, by applying the backward pumped distributed Raman amplification after improving the flatness of the GSNR to some extent by the pre-emphasis, the power of the pump light can be reduced, and the low power consumption can be achieved.

### Second Embodiment

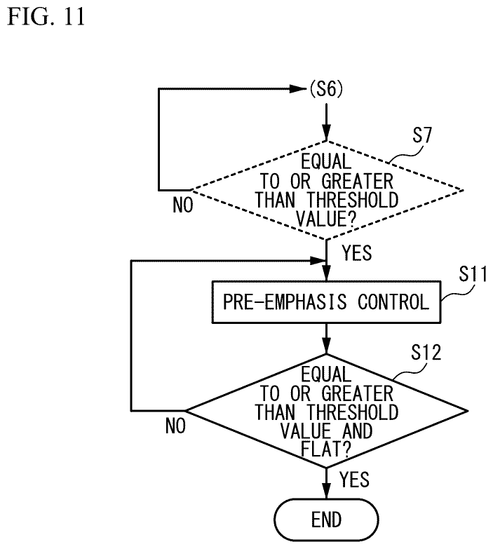

Next, a second embodiment of the present disclosure will be described with reference to FIG. 11 to FIG. 13. In the second embodiment, the pre-emphasis control for fine adjustment is further repeated. This improves the GSNR in all of the S band, the C band, and the L band, and improves the flatness in all of the S band, the C band, and the L band. In the flowchart illustrated in FIG. 11, the same parts as those in the flowchart illustrated in FIG. 4 are omitted, and thus the detailed description thereof will be omitted.

First, as illustrated in FIG. 11, in the process in step S7 described above, when the minimum GSNR of the S band is equal to or greater than the threshold value, the power control unit 143 performs the pre-emphasis control (step S11). Then, the GSNR calculation unit 142 determines whether the minimum GSNR is equal to or greater than the threshold value across the S band, the C band, and the L band and the GSNR is flat (step S12). The GSNR calculation unit 142 performs the process of step S12 based on the calculated tilt amount of the GSNR across the S band, the C band, and the L band.

When the minimum GSNR is not equal to or greater than the threshold value, or when the GSNR is not flat (step S12: NO), the GSNR calculation unit 142 repeats the processing of steps S11 and S12. When the minimum GSNR is equal to or greater than the threshold value and the GSNR is flat (step S12: YES), the transmission node control unit 140 and the reception node control unit 240 each end the process.

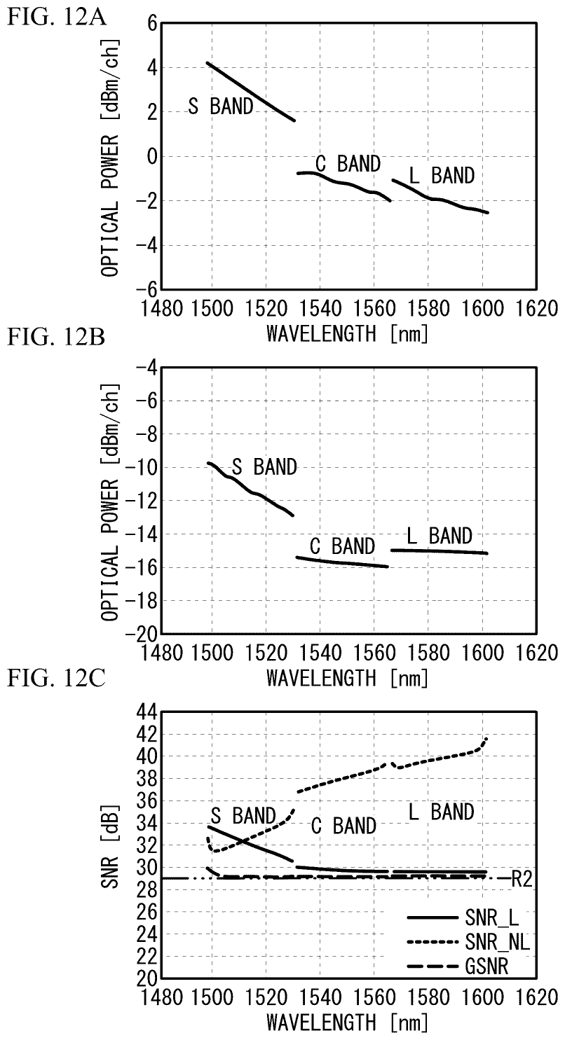

As a result, as illustrated in FIG. 12A, a tilt of the transmission power different from that illustrated in FIG. 9A is generated. When the Raman amplification by the pump light Lp is performed in a state where such a tilt is generated, as illustrated in FIG. 12C, the GSNR tilt in the S band, the C band, and the L band is reduced as compared with the case illustrated in FIG. 9C. For example, as illustrated in FIG. 12C, the GSNR tilt in the S band, the C band, and the L band is reduced by the processing in steps S11 and S12.

As a result, as illustrated in FIG. 12C, the GSNR of the S band, the GSNR of the C band, and the GSNR of the L band are flat as a whole. For example, in all of the S band, the C band, and the L band, the minimum GSNR “R1” (see FIG. 9C) such as 28.6 dB is improved to the minimum GSNR “R2” (see FIG. 12C) such as 29.2 dB.

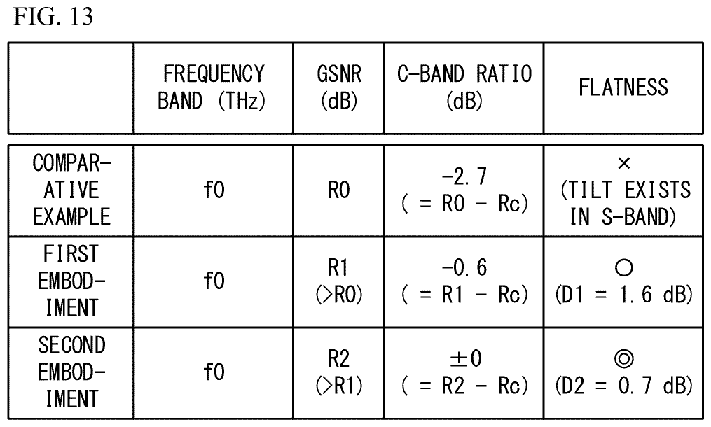

Referring to FIG. 13, the effect of the second embodiment will be described in comparison with the first embodiment. The frequency band “f0” in the second embodiment is the same as that in the first embodiment. In such a frequency band “f0”, the minimum GSNR “R1” is calculated in the first embodiment. On the other hand, in the second embodiment, the minimum GSNR “R2” larger than the minimum GSNR “R1” is calculated.

Thus, according to the second embodiment, the GSNR is improved as compared with the first embodiment. Further, when the relative C-band ratio of the first embodiment is compared with the relative C-band ratio of the second embodiment, the GSNR “R2” of the second embodiment is the same or substantially the same as the GSNR “Rc” in the WDM transmission using the C band alone. That is, according to the second embodiment, it is possible to obtain the same or substantially the same transmission performance as that of the WDM transmission using the C band alone, as compared with the first embodiment. The relative C-band ratio of the second embodiment represents the difference between the minimum GSNR “R2” and the GSNR “Rc”.

As for the flatness of the GSNR, in the second embodiment, the deviation D2 is kept to about 0.7 dB in the entire GSNR of the S band, the C band, and the L band, and the flatness is further improved as compared with the first example. As described above, in the second embodiment, the GSNR is further improved by the fine adjustment of the pre-emphasis control, as compared with the first embodiment. As a result, in the second embodiment, the transmission performance degradation is further suppressed, compared to the first embodiment.

### Another Embodiment

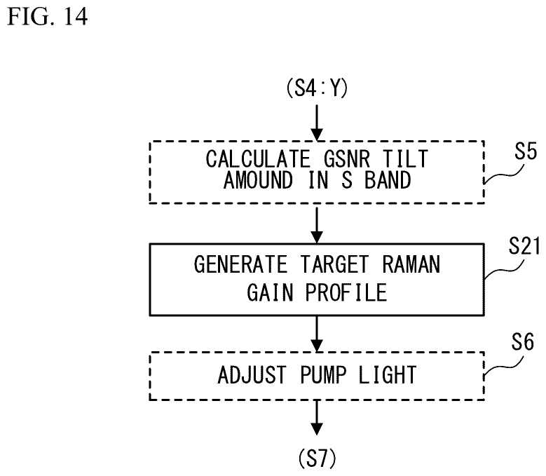

Another embodiment will be described with reference to FIG. 14. As illustrated in FIG. 14, the backward Raman control unit 242 may generate the target Raman gain profile between the process of step S5 and the process of step S6 (step S21). The target Raman gain profile is an example of gain information. The optical fiber may include an optical loss (so-called water peak) caused by hydroxide ions. When the pump light Lp is affected by the optical loss, the gain may fluctuate and the backward pumped distributed Raman amplification may become insufficient. Since the relationship between the type of optical fiber and the optical loss varies, the gain of the backward pumped distributed Raman amplification may also vary.

Therefore, before the process of step S6 is executed, the backward Raman control unit 242 generates various target Raman gain profiles corresponding to the types of the optical fiber based on the tilt amount of the S band reported from the GSNR calculation unit 142. Then, the backward Raman control unit 242 executes the processing of step S6 based on the calculated target Raman gain profile. Thus, the influence of the water peak is reduced and the transmission performance degradation is reduced.

### Third Embodiment

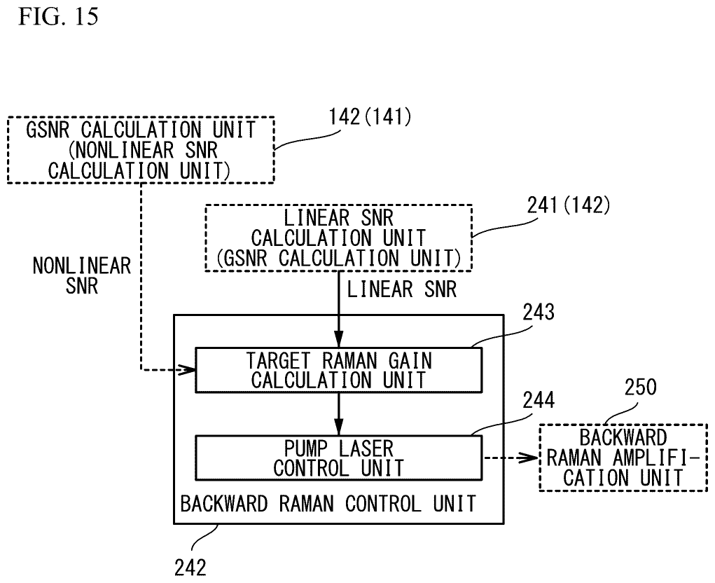

A third embodiment will be described with reference to FIG. 15. In the present embodiment, the backward Raman control unit 242 includes a target Raman gain calculation unit 243 and a pump laser control unit 244. In FIG. 4 and FIG. 14, the GSNR calculation unit 142 reports the tilt amount of the GNSR to the backward Raman control unit 242. In the present embodiment, the target Raman gain calculation unit 243 acquires the nonlinear SNR from the GSNR calculation unit 142 (or the nonlinear SNR calculation unit 141). In the present embodiment, the target Raman gain calculation unit 243 acquires the linear SNR from the linear SNR calculation unit 241 (or the GSNR calculation unit 142). The target Raman gain calculation unit 243 calculates the target linear SNR based on the acquired nonlinear SNR, the target GSNR, and the equation (5). Further, the target Raman gain calculation unit 243 generates a target Raman gain profile from the difference between the target linear SNR and the acquired linear SNR. Since the nonlinearity and the noise property are low in the backward pumped distributed Raman amplification, it is assumed that there is no influence or an extremely small influence on the nonlinear SNR of the received signal before and after the Raman amplification. The target GSNR may be stored in the memory in advance or may be input and set later.

The pump laser control unit 244 controls the backward Raman amplification unit 250 based on the target Raman gain profile reported from the target Raman gain calculation unit 243 to adjust the pump light. This allows backward pumped distributed Raman amplification to be controlled based on the GSNR, which is the quality of the optical signal in which nonlinear noise generated in the optical transmission line 300 is taken into account, thereby reducing the transmission performance degradation. Furthermore, the influence of the water peak is also reduced, and the transmission performance degradation is further suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

For example, in the above-described embodiments, the GSNR is adopted as an example, but the generalized OSNR (GOSNR) may be adopted instead of the GSNR. Even when the GOSNR is adopted, the same result as in the case where the GSNR is adopted is obtained.

In the above-described embodiments, WDM transmission using the S band, the C band, and the L band is adopted as an example. However, for example, WDM transmission using the C band, the L band, and the U band (Ultralong Band) may be adopted. It is assumed that the same result can be obtained even in WDM transmission using the C band, the L band, and the U band.

What is claimed is:

1. An optical transmission device comprising:
a reception unit that receives, from an optical transmission line, a wavelength division multiplexing (WDM) signal obtained by multiplexing a first optical signal, a second optical signal, and a third optical signal after optical power of each of the first optical signal, the second optical signal, and the third optical signal is adjusted, the first optical signal having a wavelength belonging to a first wavelength band, the second optical signal having a wavelength belonging to a second wavelength band longer than the first wavelength band, the third optical signal having a wavelength belonging to a third wavelength band shorter than the first wavelength band;
an amplification unit that amplifies the WDM signal based on an output to the optical transmission line of a pump light propagating in a direction opposite to a propagation direction of the WDM signal; and
a control unit that controls a gain of the amplification unit based on a quality of the third optical signal, the quality of the third optical signal being calculated based on optical power of the third optical signal before being transmitted to the optical transmission line and optical power of the third optical signal included in the WDM signal received by the reception unit.

2. The optical transmission device according to claim 1, wherein the control unit adjusts a gain on a short-wavelength side of the third wavelength band to a gain higher than at least one of a gain on a long-wavelength side of the first wavelength band, a gain on a long-wavelength side of the second wavelength band, or a gain on a long-wavelength side of the third wavelength band.

3. The optical transmission device according to claim 2, wherein the control unit adjusts the gain on the short-wavelength side of the third wavelength band to the gain higher than the at least one of the gain on the long-wavelength side of the first wavelength band, the gain on the long-wavelength side of the second wavelength band, or the gain on the long-wavelength side of the third wavelength band by adjusting a wavelength and the power of the pump light.

4. The optical transmission device according to claim 1, further comprising:
a demultiplexing unit that demultiplexes the WDM signal into the first optical signal, the second optical signal, and the third optical signal,
wherein the optical power of each of the first optical signal and the second optical signal is adjusted so that a quality of each of the first optical signal and the second optical signal calculated based on optical power of each of the first optical signal and the second optical signal before being transmitted to the optical transmission line and optical power of each of the first optical signal and the second optical signal demultiplexed by the demultiplexing unit before the amplification unit amplifies the WDM signal is flat, and then optical power of each of the first optical signal, the second optical signal, and the third optical signal demultiplexed by the demultiplexing unit is further adjusted so that each quality is flat after the quality of each of the first optical signal and the second optical signal is flattened.

5. The optical transmission device according to claim 1, wherein the control unit generates information on the gain of the amplification unit based on a tilt amount of a quality of the third optical signal, and controls the gain of the amplification unit based on the information.

6. The optical transmission device according to claim 1, wherein the control unit generates information on the gain of the amplification unit based on a target linear SNR and a linear SNR, and controls the gain of the amplification unit based on the information, the target linear SNR being obtained based on a target value of the quality of the third optical signal and a nonlinear SNR, and the linear SNR being calculated based on the optical power of the third optical signal included in the WDM signal received by the reception unit.

7. An optical transmission method comprising:
receiving, from an optical transmission line, a wavelength division multiplexing (WDM) signal obtained by multiplexing a first optical signal, a second optical signal, and a third optical signal after optical power of each of the first optical signal, the second optical signal, and the third optical signal is adjusted, the first optical signal having a wavelength belonging to a first wavelength band, the second optical signal having a wavelength belonging to a second wavelength band longer than the first wavelength band, the third optical signal having a wavelength belonging to a third wavelength band shorter than the first wavelength band;
amplifying the WDM signal based on an output to the optical transmission line of a pump light propagating in a direction opposite to a propagation direction of the WDM signal; and
controlling a gain of amplification based on a quality of the third optical signal, the quality of the third optical signal being calculated based on optical power of the third optical signal before being transmitted to the optical transmission line and optical power of the third optical signal included in the WDM signal that has been received.

8. An optical transmission system comprising:
a first optical transmission device that adjusts optical power of each of a first optical signal, a second optical signal, and a third optical signal, and then transmits a wavelength division multiplexing (WDM) signal obtained by multiplexing the first optical signal, the second optical signal, and the third optical signal to an optical transmission line, the first optical signal having a wavelength belonging to a first wavelength band, the second optical signal having a wavelength belonging to a second wavelength band longer than the first wavelength band, the third optical signal having a wavelength belonging to a third wavelength shorter than the first wavelength band; and
a second optical transmission device that receives the WDM signal from the optical transmission line, amplifies the WDM signal based on an output to the optical transmission line of a pump light propagating in a direction opposite to a propagation direction of the WDM signal, and controls a gain of amplification based on a quality of the third optical signal, the quality of the third optical signal being calculated based on optical power of the third optical signal before being transmitted to the optical transmission line and optical power of the third optical signal included in the WDM signal that has been received through the optical transmission line.
